(19) United States
(12) Patent Application Publication
(10) Pub. No.: US 2010/0148505 A1
(43) Pub. Date: Jun. 17, 2010

(54) CONTACT-LESS POWER AND SIGNAL TRANSMISSION DEVICE FOR A HIGH POWER LEVEL TRANSFORMER

(76) Inventors: Gregory M. Dunlap, St. Charles, IL (US); Kai Chi Chan, Bloomingdale, IL (US); Jason S. Katcha, Whitefish Bay, WI (US); Thomas A. Spengler, Kingston, IL (US); Jeremy A. Miller, Lake In The Hills, IL (US)

Correspondence Address: MICHAEL J. CHERSKOV, 300 NORTH STATE STREET, SUITE 5102, CHICAGO, IL, 60654, US

(21) Appl. No.: 12/336,195

(22) Filed: Dec. 16, 2008

(51) Int. Cl. H02P 9/04; H01F 27/00

(52) U.S. Cl. 290/44; 336/120

(57) ABSTRACT

A transformer is provided comprising a first member upon which a first circuit is wound; a second member upon which a second circuit is wound such that power is transferred to the second circuit in a contact-less manner; and a signal transmitter on the first member in close proximity to an appropriate receiver on the second member together with a signal transmitter on the second member in close proximity to an appropriate receiver on the first member such that said transmitters and receivers exchange signals in a contact-less manner, whereby the circuits are embedded in a high thermal conductivity resin. An exemplary embodiment of the invented transformer is one where the second member rotates relative to the first member.

### BACKGROUND OF THE INVENTION

1. Field of the Invention

This invention relates to an improved transformer, and more particularly, this invention relates to a transformer featuring bi-directional and contact-less signal and high level power transmission.

2. Background of the Invention

Windmills, wind turbines, and other wind-actuated power devices may utilize a rotary transformer that comprises one or more rotors and stators positioned at the top of a mast or tower.

This paradigm presents special challenges. Both the stator and especially the rotor must be small in bulk. Also, the rotor rotates at a high rate around a horizontal axis. Both the stator windings must be able to carry large currents. So, it is imperative that effective cooling be provided thereto. Also, it is imperative that the rotary transformer be able to withstand extreme weather conditions.

State of the art wind turbine systems use contacting brush and slip ring mechanisms to provide power from the stator to the rotor. These are prone to reduced reliability, frequent maintenance problems, and the generation of electrical noise that can interfere with, or damage, sensitive electronics. Oxidation and environmental agents, such as water, ice, and dust, have adverse effects on brush/slip-ring power transmission.

Eliminating brush/slip-ring mechanisms may ameliorate some of the problems associated with operations in environmentally-harsh situations. However, the state of the art of contactless electrical systems is also lacking as to data processing speed and reliability for the monitoring and control of power transmission, mechanical operating conditions (e.g. the pitch of the wind turbine blades), and temperature of the system components. Also, state of the art rotary transformers experience high temperatures in their windings that reduce power output and cause damage to the transformer.

U.S. Pat. No. 7,288,870 (Mitcham, et al.—Oct. 30, 2007) entitled “Stator core” discloses a stator core comprising laminations of low loss stator iron positioned in parallel with laminates of high thermal conductivity material regularly arranged within the core.

U.S. Pat. No. 6,069,430 (Tsunoda et. al, May 30, 2000) incorporates alumina as a high thermal conductivity layer in a film for covering windings of electrical machines.

U.S. Pat. No. 4,796,353 (Mantovani, Jan. 10, 1989) discloses an electric arbor incorporating an epoxy resin containing sand particles to improve thermal conductivity.

Concerning signal transmission, U.S. Pat. No. 6,031,949 (Davies—Feb. 29, 2000) discloses an optical slip ring system with a rotor interface which can bolt on to a high speed rotor in a modular manner. The rotor interface has circular circuit boards containing drive circuits and power supply circuits for transducers mounted on the rotor. The drive circuit on the boards drive central clusters of emitters and collector LEDs.

U.S. Pat. No. 7,043,114 (Popescu—May 9, 2006) and U.S. Pat. No. 7,265,542 (Hrubes—Sep. 4, 2007) disclose devices for contact-less signal transmission for rotary devices.

U.S. Pat. No. 7,042,109 to Gabrys (May 9, 2006) discloses an armature having resin overlying the core so as to affix the core to its underlying foundational substrate.

A need exists in the art for a rotary transformer to simultaneously, and in a contact-less configuration, transfer electrical power while reliably exchanging electronic data and commands. The transformer should accommodate power levels in the 1 megaWatt range. The device must operate in extreme environmental conditions (such as high moisture, high particulate environs) and in large ambient temperature differentials. The device must also facilitate the transfer of heat away from primary and secondary windings so as to optimize operation and longevity and therefore minimize servicing requirements.

### SUMMARY OF THE INVENTION

An object of the present invention is to provide a high power transformer that overcomes many disadvantages of the prior art.

Another object of the present invention is to provide a more efficient means of cooling electrical transformers use in wind and water turbines, computer aided tomography (CAT) equipment, and other contact-less power transmission applications. A feature of the present invention is the encapsulation of the transformer windings with high thermal conductivity resin effective up to 500° F. An advantage of the present invention is that high power output but low-mass/low-moment-of-inertia rotors can be manufactured to accommodate rotor rotation rates in the thousands of revolutions per minute (rpm). Typical rotation rates for applications where the present invention is applicable include 10-300 rpm for wind turbines, 1000 rpm for jet-engine turbines and up to 20,000-30,000 rpm for high speed drills.

Yet another object of the present invention is to provide more efficient signal transmission for control circuits in a rotary transformer. A feature of the present invention is the use of contact-less signal transmission. An advantage of the present invention is that high speed, trouble-free signal transmission between the rotor and the stator is accomplished in a turbine with rotor rpms as high as 1000.

Still another object of the present invention is to provide a rotary transformer which integrates power transmission and signal transmission features. A feature of this invention is the use of resin-encapsulated stator and rotor windings together with contactless power transmission and contactless signal transmission in power transfer systems whereby power levels as high as 1000 kilowatts are accommodated. An advantage of this invention is the application of water-, steam-, and wind-turbines to accommodate a myriad of operating conditions while preventing heat build-up within the rotor windings, to accumulate currents as high as 1000 Amps.

Another object of the present invention is to provide a rotary transformer which can accommodate power loads in excess of 1000 kilowatts by optimizing heat transfer from its windings. A feature of this invention is a plurality of segmented winding cavities each having a configuration which facilitates thermal conduction away from the longitudinally-extending surfaces of each of the wires that comprise the winding. An advantage of this feature is more efficient heat conduction away from the windings. Another advantage of this feature is a reduction in magnetic leakage.

In brief, the present invention provides a transformer that combines the advantages of contact-less power transmission and contact-less signal transmission with enhanced cooling of the current windings. The invented transformer can accommodate power levels up to 1 megaWatt and operate typically in the 10 kW to 100 kW range. An embodiment of the invented rotary transformer comprises: a stationary member comprising a first mechanical carrier with first windings thereupon; a rotary member comprising a second mechanical carrier with second windings thereupon, said rotary member in registration with said stationary member; and segmented highly permeable magnetic material disposed circumferentially on said carriers so as to form channels adapted to receive said windings, whereby said first and second windings and said magnetic material are affixed to said mechanical carriers with a high thermal conductivity resin.

The present invention also provides a rotary transformer comprising: a stationary member comprising a first mechanical carrier with first windings thereupon; a rotary member comprising a second mechanical carrier with second windings thereupon said rotary member in registration with said stationary member; segmented highly permeable magnetic material disposed circumferentially on said carriers so as to form channels adapted to receive said windings wherein said first and second windings and said magnetic material are affixed to said mechanical carriers with a high thermal conductivity resin; a power supply connected to the first windings with inductive coupling between first windings and second windings such as to induce a current in the second windings; one or more signal transmitters on the stationary member in close proximity to appropriate receivers on the rotating member; and one or more signal transmitters on the rotating member in close proximity to appropriate receivers on the stationary member such that said transmitters and receivers exchange signals in a contact-less manner.

Furthermore the present invention provides a wind turbine including a rotary transformer comprising: a stationary member with first windings thereupon; a rotary member with second windings thereupon, said rotary member in registration with said stationary member, whereby one or more of said windings are embedded in a high thermal conductivity resin; a power supply connected to the first windings together with inductive coupling between first windings and second windings such as to induce a current in the second windings; one or more signal transmitters on the stationary member in close proximity to appropriate receivers on the rotating member; and one or more signal transmitters on the rotating member in close proximity to appropriate receivers on the stationary member such that said transmitters and receivers exchange signals in a contact-less manner.

### BRIEF DESCRIPTION OF THE DRAWING

The invention together with the above and other objects and advantages will best be understood from the following detailed description of the preferred embodiment of the invention shown in the accompanying drawing, wherein:

FIG. 1 is a schematic circuit diagram of a rotary transformer device, in accordance with features of the present invention;

FIG. 2a is a cross sectional schematic view of a transformer, in accordance with features of the present invention;

FIG. 2b is a top schematic view of a stator for a rotary transformer, in accordance with features of the present invention;

FIG. 2c is a top schematic view of a rotor for a rotary transformer, in accordance with features of the present invention;

FIG. 3 is a schematic view of a rotor juxtaposed to a stator, in accordance with features of the present invention;

FIG. 4 is a schematic view of the invented contact-less power and signal transmission device applied to a wind turbine, in accordance with features of the present invention;

FIG. 5 is a schematic view of a cross-section of a winding groove taken along line 5-5 in FIG. 2b in accordance with features of the present invention; and

FIG. 6 is a schematic cross-sectional view of an exemplary configuration of emitter and receiver LEDs in the invented contact-less power and signal transmission device applied to a wind turbine, in accordance with features of the present invention.

### DETAILED DESCRIPTION OF THE INVENTION

The present invention discloses a device and a method to be used in conjunction with high power (more than 1,000 kW) electric generation and transmission, including applications involving the use of stationary or rotary transformers where power and signals must be transferred to or from a stationary or a mobile platform (e.g. high-power transformers, motors, generators, turbines, CAT-scan devices, etc.) One especially important area of application of the present invention is electrical power transfer from stator to rotor for wind-power turbines. Another promising application is “micro-turbines,” especially “micro-hydro turbines” that employ running water to provide power to a home or a running stream to provide power at a remote location. In general, the present invention facilitates power transfer under conditions that require the use of compact precisely-controlled rotary transformers.

A contactless power transfer system is provided comprising a primary member with strong inductive coupling to a secondary member, the combination of the two members constituting, in one embodiment, a rotary transformer having contact-less power transmission and contact-less signal transmission, a combination that provides unique advantages. The rotary transformer may be employed in all situations where power and signals must be transferred to or from a mobile platform (e.g. motors, generators, wind turbines, CAT-scan devices, etc.). The “rotor” may rotate at a variable frequency as high as 30,000 rpm. Both rotor and stator feature electrically conducting windings capable of sustaining high currents at high frequencies. Rapid exchange of data between stator and rotor facilitate the operation of the transformer at high power, up to 1000 kW. Typical power requirements are from 1 kW to 400 kW.

The high-power transfer entails high heat output with the generation of temperatures as high as 450° C. Operation with such high heat output is facilitated via heat conduction means in intimate thermal contact with the windings to conduct heat there from.

Contact-less data transmission can be effected by means of the exchange of electro-static, magnetic, radio, infra-red, or visible-light signals. For the sake of illustration, this application will deal primarily with exchange of infra-red signals by means of LEDs.

The invented rotary transformer can be used in conjunction with a wind turbine or a CT scanner. A wind turbine embodying features of the present invention comprises a stationary member with windings thereupon; a rotary member with windings thereupon; whereby one or more of said windings are embedded in a high thermal conductivity resin; inductive coupling between stator windings and rotor windings such as to induce a current in the rotor; one or more signal transmitters on the stationary member in close proximity to appropriate receivers on the rotating member; and one or more signal transmitters on the rotating member in close proximity to appropriate receivers on the stationary member such that said transmitters and receivers exchange signals in a contact-less manner.

The invented rotary transformer combines inductive energizing of rotor windings with multi-directional data transmission at currents up to 1000 Amps. The inventors have adapted exemplary features of a low level power transfer system as described in U.S. Pat. No. 7,054,411 and issued on May 30, 2006 to Katcha (one of the inventors of the present invention). The '411 patent is hereby incorporated by reference.

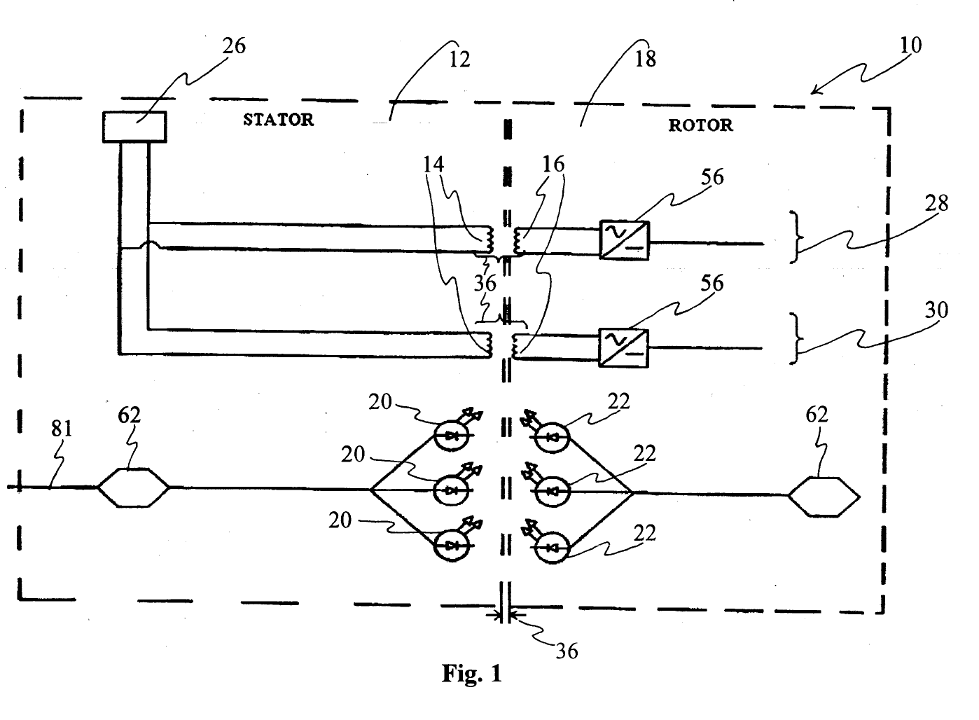

FIG. 1 is a circuit diagram for an exemplary embodiment of a rotary transformer, designated as numeral 10, for a wind turbine application. The system comprises a stationary member 12 (i.e. a stator) and a rotating member 18 in rotatable relation to the stationary member 12 with an air gap 36 there between. The stationary member 12 comprises a winding (or windings) 14 configured to be inductively coupled to windings 16 on the rotor so as to receive power there from . The rotating member (rotor) 18 is configured to receive power as it is rotated. The rotor comprises a rotating core and separate sub-windings 16, each said sub-winding including a forward path and a return path circumferentially disposed along the rotating core, the forward path and return path of each said sub-winding rotating proximate to and spaced a substantially equal distance from the winding 14 disposed on the stationary member.

The stationary member supports a first signal transceiver (or a first plurality of signal transceivers) 20. These first signal transceivers are positioned in close spatial relationship to a complementary second transceiver (or a second plurality of signal transceivers) 22 which is supported by the rotor 18. Sensors 62 mounted on the rotor provide data to transceivers 22. The gap 36 between the two transceivers is usually between 0.5 mm and 1.5 mm but gaps as large as 2.5 mm can be accommodated. The transceivers 20 supply data to a control computer through a signal cable 81.

A power supply or an inverter 26, which may or may not be remotely situated to the rotary transformer provides power to windings 14. The power supply supplies power at a voltage of 200-800 V and at frequencies between 1 kHz and 1 MHz and more typically between 20 kHz and 100 kHz.

The voltage induced in the windings 16 is proportional to the frequency of the power supply 26. After rectification by the rectifying circuits 56 the power induced in the windings 16 is delivered to a co-rotating load by means of power cables 28 and 30.

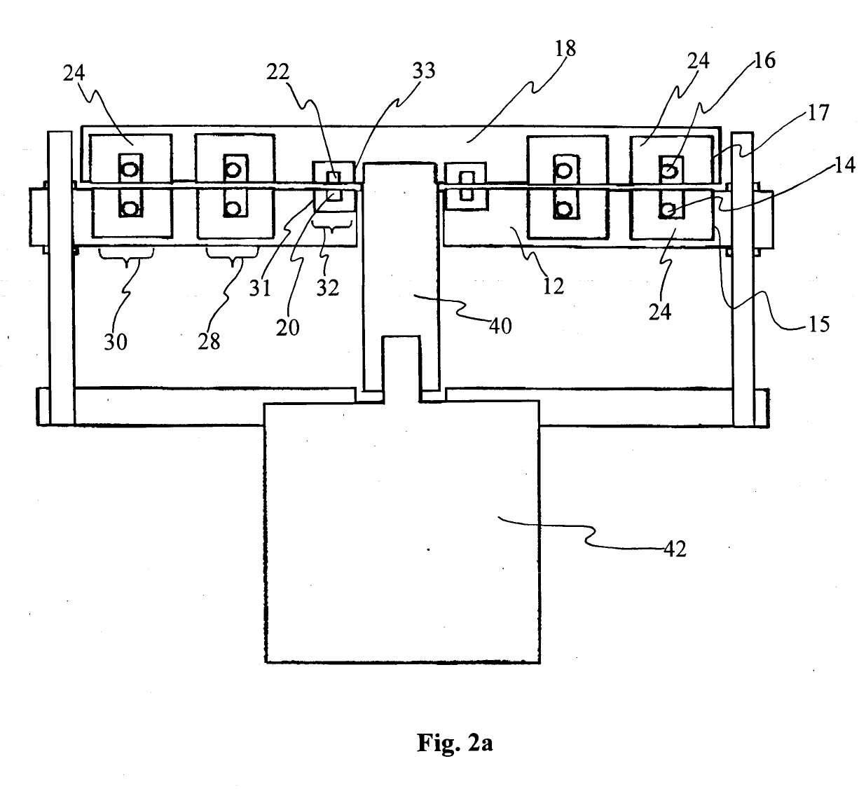

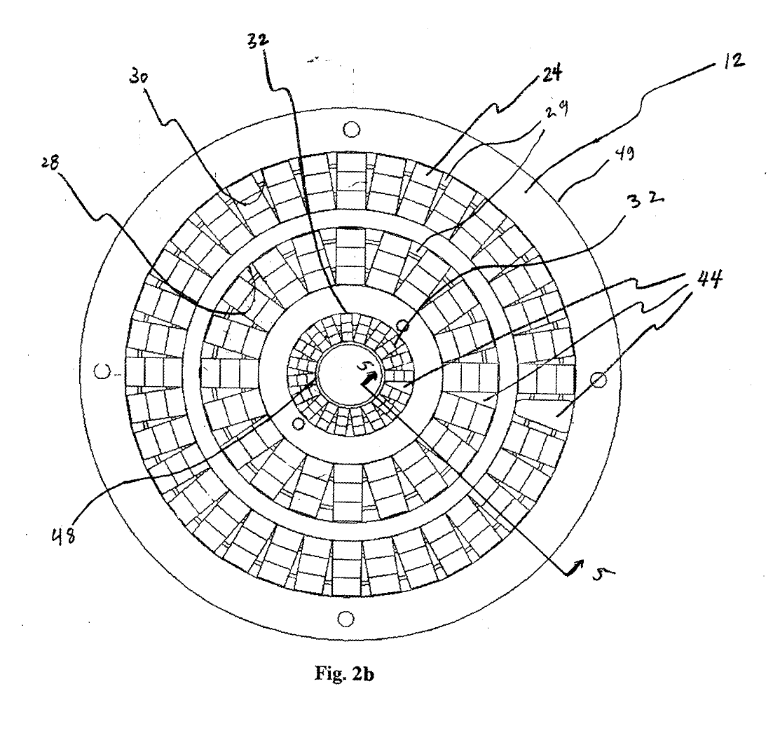

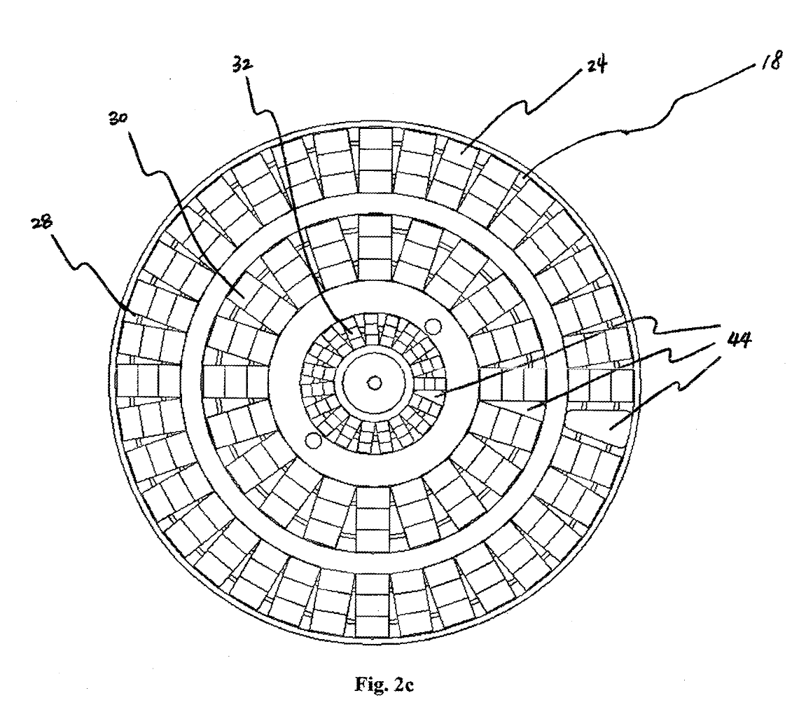

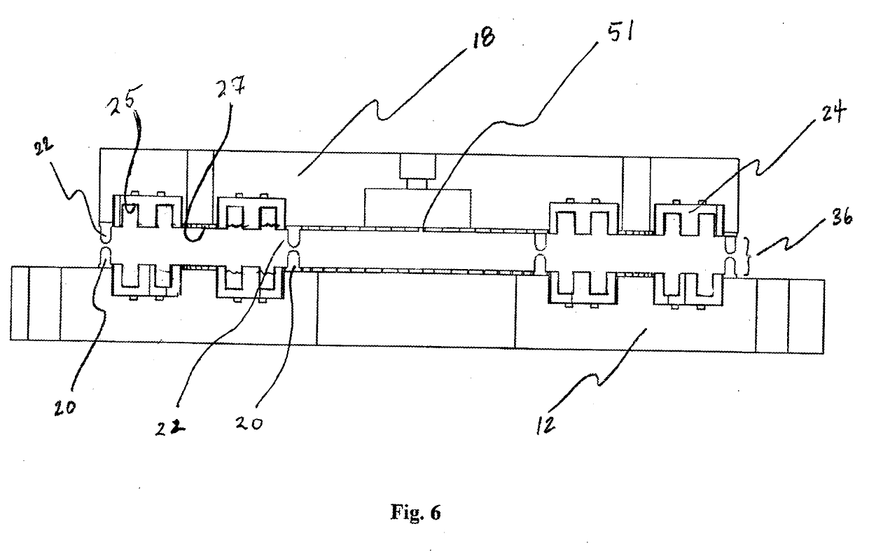

FIG. 2a is a schematic cross sectional view of a rotor/stator assembly. The stator 12 comprises annular groves 15 lined with ferrite ingots 24 forming channels 28 and 30 to accommodate the stator windings 14. An annular groove 31 receives the stator transceivers 20. The rotor 18, attached to an axle 40, comprises annular groves 17 filled with ferrite (or other suitable low magnetic reluctance material) cores 24 which accommodate the rotor windings 16. An annular groove 33 receives the rotor transceivers 22. Typically, the ingots 24 are approximately 1 in. long ingots of low magnetic reluctance material (e.g. ferrites) that are rigidly attached to each other and to the rotor or stator body by means of a high-thermal-conductivity epoxy resin. As depicted in FIG. 6, the resin fills substantially the entire channel 25 defined by the cores so as to completely submerge the windings residing in the channel while also remaining below the face 27 defined by the rotor 18 and the stator 12.

The ingots may be rectangular or have a u-shaped or an e-shaped cross section. The short-ingot/epoxy-resin construction allows the winding-bearing rings to withstand the very large centrifugal forces present in some applications (4 million g for a 1 m rotor rotating at 1000 rpm). Also, the epoxy filling the gaps between the rectilinear ingots and therefore contacting the surfaces of the ingots enhances heat conduction away from the windings. The arrangement of the windings is similar to that detailed in U.S. Pat. No. 7,197,113 (issued on Mar. 27, 2007, to co-inventor Katcha) the entirety of which is incorporated herein by reference.

FIG. 2b is a schematic top view of a contact-less stator showing two u-shaped power channels 28 and 30 and a u-shaped transceiver channel 32. The channels are filled with a plurality of rectilinear ferrite ingots 24, with the interstices 29 between ingots filled with high thermal conductivity epoxy resin. Each channel defines a transverse aperture 44 extending through the stator through which wire enters or exits the channel. The stator has an outer periphery 49 and an inner periphery 48 designed to provide clearance for the axle 40.

FIG. 2c is a schematic top view of a contact-less rotor showing two u-shaped power channels 28 and 30 and a u-shaped transceiver channel 32. The channels are formed by rectilinear ferrite ingots 24 with the interstices 29 between ingots filled by high thermal conductivity epoxy resin. Each groove has a gap 44 through which wire enters or exits the groove.

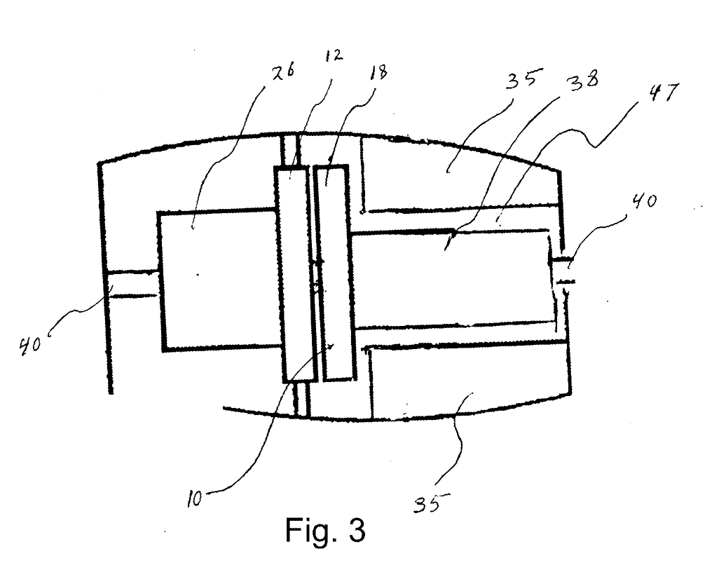

FIG. 3 is a schematic view of the transformer stator 12 in close spatial relationship to the transformer rotor 18. Also visible is the power supply 26 to which power is brought from the outside (not shown), and a turbine 47 with a rotor 38 and a stator 35. The rotors are attached to each other and to the rotating shaft 40.

A low magnetic reluctance is necessary to accommodate the high-frequency induced magnetic field provided by the power supply 26. Suitable low magnetic reluctance materials include ferrites, nickel, nanocrystalines, and powdered iron. The nanocrystalline FINEMET® developed by Hitachi Metals is especially suitable. FINEMET® it is a soft material with a high saturation flux density, a high permeability, and stable temperature characteristics. The use of FINEMET® allows a reduction in the bulk and weight of the transformer components.

Ferrites are especially advantageous in this application due to their low mass density and low magnetic reluctance. Ferrites are dense, homogeneous ceramic compounds composed mainly of iron oxide (Fe₂O₃) and carbonates of metals such as magnesium, zinc, nickel, or manganese. The mixture is pressed and then fired in a kiln.

Nickel is another material possessing low magnetic reluctance. Nickel has the advantage of being slow to react in air at normal temperatures.

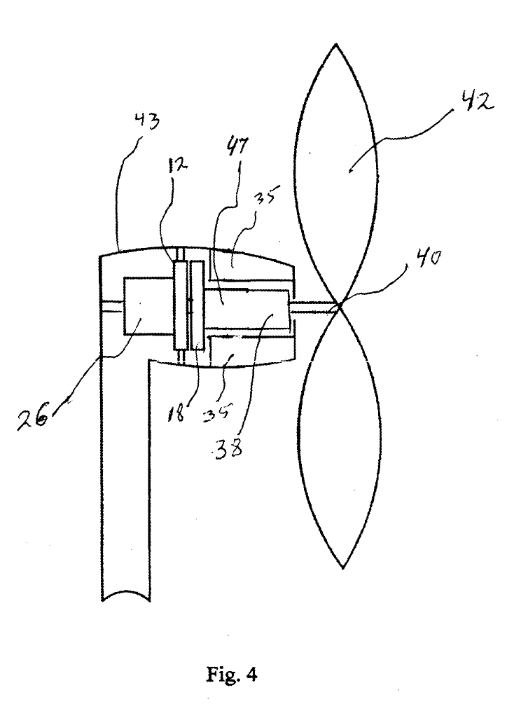

FIG. 4 is a schematic of the invented contactless transformer as applied to a wind turbine 47. Analogous to the configuration of FIG. 2a, the stator 12 and rotor 18 are juxtaposed in close spatial relation to each other. Generally, the turbine 47 comprises a wind catcher such as a blade or plurality of blades 42 attached to the turbine rotor 38 through a shaft 40. The transformer rotor 18 is attached to the turbine rotor 38. The turbine is mounted in a housing (such as a nacelle) 43 containing the turbine rotor 38 and the transformer rotor 18, the turbine stator 35 and the transformer stator 12 as well as the power supply 26. The nacelle is designed to maintain “line of sight” conditions between transceivers on the stator and rotor. A power cable delivers electrical power from the turbine stator 35 to the outside. Further description of a suitable wind turbine in the commonly owned co-pending application U.S. Ser. No. 12/016,824 “Contactless Power and Data Transmission Apparatus” by inventors Katcha, Dunlap, and Chan, the entirety of which is incorporated herein by reference.

Other depictions of contactless transformer windings can be found in U.S. Pat. No. 7,197,113 (issued on Mar. 27, 2007, to co-inventor Katcha) the entirety of which is incorporated herein by reference.

### High Power Operation

Contact-less cooling of the rotor requires efficient heat transfer from the current-bearing windings of the rotor to the ambient atmosphere. Efficient heat transfer from the current-bearing windings of the stator to the ambient atmosphere is also required. Ferrites, or other suitable low magnetic reluctance materials, often used for the rotor and/or the stator, must be kept at a temperature of less than 180° C. in order to prevent a drop in the magnetic permeability of the material.

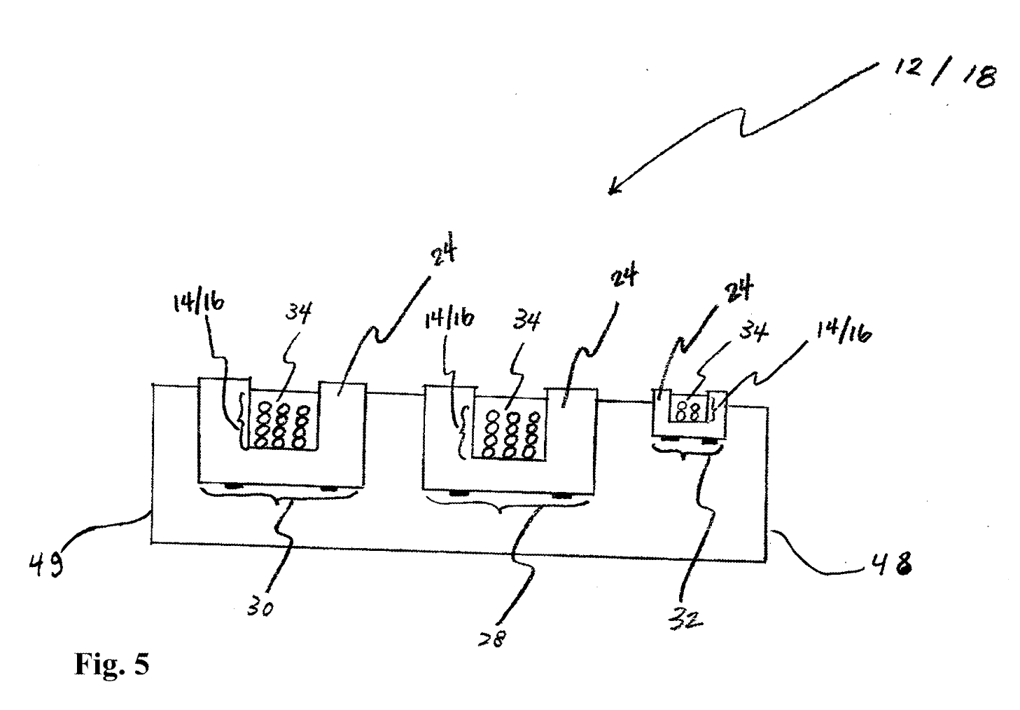

In an embodiment of the present invention, current-bearing windings are nested in annular grooves having an “U”-shaped cross section as depicted in FIG. 5. FIG. 5 is a schematic view of a cross-section of a winding groove taken along line 5-5 in FIG. 2b . The grooves 28, 30, and 32 are lined with a high magnetic permeability material 24 (e.g., ferrite) that channels the magnetic flux from stator to rotor and conversely. The “U”-shape allows better containment of stray magnetic fields in the vicinity of the windings. (“E”-shaped ingots are also suitable) The windings are coated with the same high thermal conductivity epoxy resin 34 as that used to construct the groove-bearing rings. One suitable commercially available resin is Durapot 865 available from Cotronics Corporation of Brooklyn, N.Y. This arrangement allows rapid heat transfer from the windings to the rotor whence heat is transferred to the atmosphere by air currents convection.

Preferably, the wire windings consist of ‘Litz’ wire. Litz wire is especially advantageous because of the high frequency power provided by the power supply 26. Litz wire consists of a braid of many thin wires, individually coated with an insulating film and twisted together following a carefully prescribed pattern designed to minimize the additional alternating current resistance caused by the ‘skin effect’ and the ‘proximity effect.’ The ‘skin effect’ refers to the tendency of a high frequency alternating electric current to distribute itself within a conductor so that the current density near the surface of the conductor is greater than that at its core. Thus the effective resistance of the conductor increases with the frequency of the current.

The ‘proximity effect’ refers to the fact that an alternating magnetic field is produced by an alternating current flowing through an isolated conductor and that this alternating magnetic field in turn induces eddy currents within adjacent conductors, altering the overall distribution of current flowing through them.

Wire is laid in a groove so that the top of the wire is below the rim of the groove. In an embodiment of the invention, Litz wire is laid in the groove so that the top of the winding is 0.078 mm below the rim of the ferrite core 24. As depicted in FIG. 2a, preferably wires 14 and 16 are laid one or two layer thick inside a groove. This arrangement allows much stronger magnetic coupling between primary and secondary windings by minimizing magnetic leakage and much more efficient heat transfer from the windings by maximizing the surface area of the winding. The total ohmic resistance of a winding 14 or 16 is 0.01 Ohm. While still liquid, epoxy is poured in the groove so that it submerges the wire but remains below the rim of the groove.

### Resin Detail:

Generally, any resin which has a very high thermal conductivity (above 8 (BTU-in/hr° Fft²)), low magnetic reluctance, and very high electrical resistivity (10¹⁶ ohm. per cm or above) is suitable. This resin serves to provide insulation between the wires comprising each of the windings. For example, Durapot has a thermal conductivity of 20 (BTU-in/hr° Fft²). Its formulation is based on Novolac resin and Amine hardener.

Typically, epoxy resins have other advantages, including a low thermal expansion, 4.5×10⁻⁵/° C.; the ability to withstand temperatures higher than 200° C.; and a melting point for the fully cured epoxy of 250° C.

A resin with a very high thermal conductivity is also used in assembling the ferrite cores that are used in constructing the rotor and the stator.

The inventors have found that high thermal conductivity epoxy resins allow the construction of a rotor with an outer area of less than 1 square meter carrying a steady state current as high as 1000 Amperes and dissipating 10 kWatts of thermal energy, i.e. a rate of heat dissipation of 10 kWatts/square meter and a stator with an outer area of less than 1 square meter carrying a current as high as 1000 Amperes and dissipating 10 kWatts of thermal energy, i.e. a rate of heat dissipation of 10 kWatts/square meter.

Using the high thermal conductivity epoxy resin one can achieve power transfer levels above 100 kWatt, otherwise one cannot go beyond 20 kW.

### Signal Transmission

In order to provide real-time control of the device and to prevent run-away conditions, it is preferable to aggregate information from the rotor to a central data-collection and processing point. In one embodiment, the central data collection and processing unit is remote from any one rotor and acts as a centralized location for multiple rotors.

Turning to the data collection procedure, this step occurs in two stages. First, measurements are made using contact-less sensors. Second, the measurements are aggregated and transmitted for recording, processing, and originating operating commands.

The invention discloses the use of contact-less sensors on the rotating rotor to provide sensor readings regarding such variables as the rotor velocity of rotation. In one embodiment, the rotating rotor includes signal transmitter, such as an energized light-emitting diode. In other embodiments, the signal transmitter comprises several light emitting diodes placed at known locations on a the perimeter of the movable rotor. As shown in FIG. 6, the LEDs may be situated in a small circle circumscribing the center 51 of the rotor 18. The LEDs at the center may be positioned in clusters so that if one fails, another one takes its place. This is cannot be done as effectively at the perimeter because of the larger relative linear velocity between the rotor and the stator. In yet other embodiments, contact-less data transmission is effected by means of the exchange of infra-red signals, ultra-violet signals, or localized radio transmissions.

In an embodiment of the invention, the stator contains a number of signal receivers, such as light-emitting diodes. It is well-understood that light-emitting diodes feature complementary responses in regards to light. That is, when voltage is applied to a light-emitting diode, the diode becomes luminescent. However, when the opposite occurs, i.e. an unpowered diode is exposed to light, the diode reflects a voltage differential between the diode's p-side (the anode) to the diode's n-side (the cathode).

In relying on this property of light-emitting diodes, the stator includes a set of unpowered diodes distributed around a circumference of the stator. The circumference of the stator receivers is aligned with the transmitters located on the movable rotor. The receiving diodes are monitored for voltage generated across the two sides of each diode. As the rotor rotates, the energized diode passes over each of the receiver diodes. The energized transmitter briefly powers each receiver.

The second stage of the data collection process comprises the aggregation of the sensor readings. In one embodiment, the aggregation of data involves grouping voltage readings from each of the receiving diodes into data to be transmitted over a number of possible transmission means. In one embodiment, the voltage readings from each sensor are aggregated and stored in sequentially numbered data packets. Therefore, during movement of the rotor, a stream of the data packets is generated. The data packets are in turn transmitted over any established medium for transmitting data packets, such as one or more of a telephone network, a direct cable connection using a serial or parallel cable, a local area network, a wide area network, and a wireless network. Given that the receiver readings are aggregated into data packets, the readings can be transmitted over any packet-switched networks and regardless of the protocol used by the network. If a publicly-accessible packet-bearing network is employed, the receiver readings would be encrypted following aggregation to ensure a secure transmission of data.

In one embodiment, the invention couples several moving rotors with a single data collection and processing unit. Each movable rotor transmits data to the central data collection point using the data transmission process described above. The central data collection point includes means for receiving data packets, complimentary to the means for sending packets employed by each transmitting stator.

The central data storage and processing unit provides for temporary and long-term storage of the data streams received from each stator. In one embodiment, the central data storage unit comprises a dedicated computer-readable memory designed to store data streams as a cache of data. In another embodiment, the data storage unit comprises a general-purpose computer running custom software for receiving the data packets. In either embodiment, the received data packets are captured and stored in a computer-readable memory medium, such as computer RAM or any form of writable non-volatile or volatile memory.

Upon collection of the data, in one embodiment, the invention also includes a data processing unit. The data processing unit may be integral to the data collection unit, but in some embodiments the data processing unit is separate from the data collection unit. Also, in other embodiments, multiple data processing units are coupled with a single data collection unit.

In one embodiment of the invention, the data processing unit processes the data streams stored within the data storage unit so as to report on particular desired variables which can be interpolated from the data streams. For example, in one embodiment where the transmitter and receivers are used to measure the speed of the rotor, the data processing unit will process the data streams to provide information on the rotor rotational velocity and other variables related to the ones directly contained by the data stream. For example, in one embodiment one of such derived variables is current generated by the rotor. The current generated is a function of the rotational velocity and so can be derived from the data stream originating from matching sensors on the rotor and the stator.

In a first embodiment, signals are sent from emitter LEDs on an inner diameter on a stationary member or stator to receiver LEDs on the rotating rotor positioned to come in close contact with the emitter LEDs. Similarly, signals are sent from emitter LEDs on an outer diameter of the rotating member to receiver LEDs on the stationary member positioned to come in close contact with the emitter LEDs.

In the alternative embodiment of the invention, diodes emitting different frequencies of light can be arranged on different parts of the rotor. Signals received from each class of diode can be used to analyze the performance of each component of the rotor.

The inventors have achieved data transmission rates of 1 Megabits per second for rotor rotation rates of up to 300 rpm. Reliable data transmission can be achieved at rotation rates as high as 30,000 rpm.

While the invention has been described with reference to details of the illustrated embodiment, these details are not intended to limit the scope of the invention as defined in the appended claims.

1. A rotary transformer comprising:
a) a stationary member comprising a first mechanical carrier with first windings thereupon;
b) a rotary member comprising a second mechanical carrier with second windings thereupon, said rotary member in registration with said stationary member;
c) segmented highly permeable magnetic material disposed circumferentially on said carriers so as to form channels adapted to receive said windings
whereby said first and second windings and said magnetic material are affixed to said mechanical carriers with a high thermal conductivity resin.

2. The transformer as recited in claim 1 wherein the resin substantially submerges the windings.

3. The transformer as recited in claim 1 wherein the rotary member receives power inductively at a frequency of up to 300 kHz.

4. The transformer as recited in claim 1 wherein the windings are laid in the channels in layers with no more than four windings per layer.

5. The transformer in claim 3 used in conjunction with a power generating system.

6. The transformer as recited in claim 1 said resin has a thermal conductivity higher than 8 (BTU-in/° FHr.Ft²).

7. The transformer as recited in claim 1 further comprising
a) one or more signal transmitters on the stationary member in close proximity to appropriate receivers on the rotary member; and
b) one or more signal transmitters on the rotary member in close proximity to appropriate receivers on the stationary member
such that said transmitters and receivers exchange signals in a contact-less manner.

8. The transformer as recited in claim 7 wherein the signals are electrical, or radio, or infrared, or visible light, or optical, or magnetic or combinations thereof.

9. A transformer comprising:
a) a stationary member comprising a first mechanical carrier with first windings thereupon;
b) a rotary member with comprising a second mechanical carrier with second windings thereupon said rotary member in registration with said stationary member;
c) segmented highly permeable magnetic material disposed circumferentially on said carriers so as to form channels adapted to receive said windings wherein said first and second windings and said magnetic material are affixed to said mechanical carriers with a high thermal conductivity resin;
d) a power supply connected to the first windings with inductive coupling between first windings and second windings such as to induce a current in the second windings;
e) one or more signal transmitters on the stationary member in close proximity to appropriate receivers on the rotating member; and
f) one or more signal transmitters on the rotating member in close proximity to appropriate receivers on the stationary member such that said transmitters and receivers exchange signals in a contact-less manner

10. The transformer in claim 8 wherein the rotary member receives power inductively at a voltage of 800 Volts.

11. The transformer as recited in claim 9 wherein the rotary member receives power inductively at a frequency up to 300 kHz.

12. The turbine as recited in claim 9 wherein said windings are laid in channels in layers with no more than two windings per layer.

13. A rotary transformer comprising:
a) a stationary member;
b) a rotary member, said rotary member in registration with said stationary member;
c) one or more signal transmitters on the stationary member in close proximity to appropriate receivers on the rotating member; and
d) one or more signal transmitters on the rotating member in close proximity to appropriate receivers on the stationary member such that said transmitters and receivers exchange signals in a contact-less manner.

14. The rotary transformer as recited in claim 13 wherein the signals are electrical, or radio, or infrared, or visible light, or optical, or magnetic or combinations thereof.

15. The transformer as recited in claim 13 wherein the second member receives power inductively at a voltage of 800 Volts.

16. The transformer as recited in claim 13 wherein the second member receives power inductively at a frequency up to 300 kHz.

17. The transformer as recited in claim 13 wherein the means for conducting heat is resin with a thermal conductivity higher than 8 (BTU-in/° FHr.Ft²).

18. A wind turbine including a rotary transformer comprising:
a) a stationary member with first windings thereupon;
b) a rotary member with second windings thereupon, said rotary member in registration with said stationary member;
whereby one or more of said windings are embedded in a high thermal conductivity resin;
c) a power supply connected to the first windings together with inductive coupling between first windings and second windings such as to induce a current in the second windings;
d) one or more signal transmitters on the stationary member in close proximity to appropriate receivers on the rotating member; and
e) one or more signal transmitters on the rotating member in close proximity to appropriate receivers on the stationary member such that said transmitters and receivers exchange signals in a contact-less manner.

19. The turbine as recited in claim 18 wherein the power supply delivers power at a frequency as high as 300 kHz.

20. The turbine as recited in claim 18 wherein said windings comprise Litz wire.
